(19) United States
(12) Patent Application Publication
(10) Pub. No.: US 2026/0219115 A1
(43) Pub. Date: Jul. 30, 2026

(54) THERMOMETER CALIBRATOR AND METHODS OF CALIBRATING THE SAME

(71) Applicant: Tel-Tru, Inc., Rochester, NY (US)

(72) Inventors: George VASSILAROS, Rochester, NY (US); Sam DIAZ, Rochester, NY (US)

(73) Assignee: Tel-Tru, Inc., Rochester, NY (US)

(21) Appl. No.: 19/037,682

(22) Filed: Jan. 27, 2025

(51) Int. Cl. G01K 15/00; G01K 1/14; G01K 1/16

(52) U.S. Cl. CPC G01K 15/005; G01K 1/14; G01K 1/16; G01K 15/002

(57) ABSTRACT

A thermometer calibrator includes a housing containing a thermally controlled receptacle configured to receive stems of thermometers to be calibrated at one or more set point temperatures. A microcontroller is disposed within the housing and has a memory in communication with a processor. The memory is configured to store set point temperature control data indicative of the one or more set point temperatures. The microcontroller is configured for electrical communication with an external calibration system. Thermal control circuitry is disposed within the housing and in electrical communication with the microcontroller. The thermal control circuitry is configured to control the temperature of the receptacle at the one or more set point temperatures based on the set point temperature control data. The thermometer calibrator is configured to be calibrated to control the temperature of the receptacle at the one or more set point temperatures via control signals from the external calibration system.

### TECHNICAL FIELD

The present disclosure relates to thermometer calibrators and methods of calibrating the same. More specifically, the disclosure relates to thermometer calibrator that are configured to be calibrated at the one or more set point temperatures via control signals from an external calibration system.

### BACKGROUND

Stem thermometers have a stem which can be inserted into a medium to measure its temperature. One popular use for stem thermometers is monitoring cooking food, especially meat.

In cooking, a dial and a pointer of a stem thermometer typically indicate the temperature of the interior of the food. These thermometers need to be calibrated occasionally to ensure accurate temperature measurement and, in the case of food monitoring, optimum cooking of the food. An improperly adjusted or off-calibration thermometer can cause serious problems. In the case of meat cooking, undercooking can result in serious illness, while overcooking shrinks the meat and alters the flavor, making the meat less palatable.

Thermometer calibrators, such as the kind described in U.S. Pat. No. 5,678,923, filed on Jul. 13, 1995, which is herein incorporated by reference in its entirety, can be used to calibrate the stem thermometers. These types of prior art thermometer calibrators include a housing containing a thermally controlled receptacle configured to receive the stems of uncalibrated thermometers. The receptacle may be heated to one or more set point temperatures, at which the uncalibrated thermometers may be calibrated. These thermometer calibrators may include a socket in the housing, which engages and holds an adjustment nut of the uncalibrated thermometer, so that the casing of the thermometer can be adjusted while the thermometer remains inserted in the thermometer calibrator.

Such prior art thermometer calibrators themselves are required to be calibrated, either during manufacturing or periodically during use. Problematically, however, these themometer calibrators are calibrated primarily by hand, wherein a technician must manually adjust various devices in the circuitry that controls the temperature of the receptacle.

Manual calibration can be inaccurate and time consuming. This can be especially problematic during manufacture of the thermometer calibrators, wherein delays caused by manual calibration can slow down an assembly line.

Accordingly there is a need for a thermometer calibrator that can be automatically or semi-automatically calibrated. Additionally, there is a need for a method of automatically or semi-automatically calibrating a thermometer calibrator. Moreover, there is a need for a computerized system that can interface with a thermometer calibrator to automatically or semi-automatically calibrate the thermometer calibrator.

### BRIEF DESCRIPTION OF THE INVENTION

The present disclosure offers advantages and alternatives over the prior art by providing a thermometer calibrator configured to be calibrated at the one or more set point temperatures via control signals from a computerized external calibration system. The present disclosure also offers advantages and alternatives over the prior art by providing methods for automatically or semi-automatically calibrating a thermometer calibrator with such an external calibration system

A thermometer calibrator in accordance with one or more aspects of the present disclosure includes a housing containing a thermally controlled receptacle configured to receive stems of uncalibrated thermometers to be calibrated at one or more set point temperatures. A microcontroller is disposed within the housing. The microcontroller has a memory in communication with a processor. The memory is configured to store set point temperature data indicative of the one or more set point temperatures. The microcontroller is configured for electrical communication with an external calibration system. Thermal control circuitry is disposed within the housing and in electrical communication with the microcontroller. The thermal control circuitry is configured to control the temperature of the receptacle at the one or more set point temperatures based on the set point temperature data. The thermometer calibrator is configured to be calibrated to control the temperature of the receptacle at the one or more set point temperatures via control signals from the external calibration system.

A computer implemented method for calibrating a thermometer calibrator with an external calibration system in accordance with one or more aspects of the present disclosure includes inserting a stem of a calibrated thermometer into the receptacle. The calibrated thermometer has been previously calibrated to have an acceptable accuracy, via an external calibration process traceable to a predetermined standard, to at least a first set point temperature of one or more set point temperatures. A calibrated thermometer signal indicative of a temperature of the stem is sent to the external calibration system from the calibrated thermometer. A command signal from the external calibration system is sent to the thermometer calibrator to control the temperature of the receptacle at the at least first set point temperature based on set point temperature control data indicative of the one or more set point temperatures stored in a memory of a microprocessor of the thermometer calibrator. The command signal is received by the thermometer calibrator. The temperature of the receptacle is thermally controlled by the thermometer calibrator at the at least first set point temperature based on the set point temperature control data. Feedback status signals are sent from the thermometer calibrator to the external calibration system indicative of the status of the thermally controlled receptacle having reached the at least first set point temperature. The feedback status signals are received by the external calibration system. If the calibrated thermometer signal indicates that the temperature of the stem is not within a predetermined tolerance range of the at least first set point temperature, then adjustments to the set point temperature control data are calculated by the external calibration system. Control signals are sent from the external calibration system to the thermometer calibrator to adjust the set point temperature control data in accordance with the calculated adjustments. The control signals are received by the thermometer calibrator. The steps of thermally controlling, sending feedback status signals, receiving feedback status signals, calculating adjustments, sending control signals and receiving control signals are repeated until the calibrated thermometer signal indicates that the temperature of the stem is within the predetermined tolerance range of the at least first set point temperature.

An external calibration system configured to calibrate a thermometer calibrator to control a temperature of a receptacle of the thermometer calibrator at one or more set point temperatures in accordance with one or more aspects of the present disclosure includes a computer system. The computer system includes at least one calibration system memory and one or more calibration system processors in communication with the at least one calibration system memory. The computer system is configured to perform a method. The method includes receiving a calibrated thermometer signal from a calibrated thermometer indicative of a temperature of a stem of the calibrated thermometer inserted into the receptacle of the thermometer calibrator. The calibrated thermometer has been previously calibrated to have an acceptable accuracy, via an external calibration process traceable to a predetermined standard, to at least a first set point temperature of the one or more set point temperatures. A command signal is sent to the thermometer calibrator to control the temperature of the receptacle at the at least first set point temperature of the one or more set point temperatures based on set point temperature control data indicative of the one or more set point temperatures stored in a memory of a microprocessor of the thermometer calibrator. Feedback status signals are received from the thermometer calibrator indicative of the status of the thermally controlled receptacle having reached the at least first set point temperature. If the calibrated thermometer signal from the calibrated thermometer indicates that the temperature of the stem is not within a predetermined tolerance range of the at least first set point temperature, then adjustments are calculated to the set point temperature control data. Control signals are sent from the external calibration system to the thermometer calibrator to adjust the set point temperature control data in accordance with the calculated adjustments. The steps of receiving feedback status signals, calculating adjustments and sending control signals are repeated until the calibrated thermometer indicates that the temperature of the stem is within the predetermined tolerance range of the at least first set point.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits and advantages described herein.

### BRIEF DESCRIPTION OF THE DRAWINGS

The disclosure will be more fully understood from the following detailed description taken in conjunction with the accompanying drawings, in which:

FIG. 1 depicts an example of a perspective view of a thermometer calibrator, according to aspects described herein;

FIG. 2, depicts an example of a fragmentary cross sectional side view of a receptacle of the thermometer calibrator of FIG. 1, taken along the line 2-2 of FIG. 1, according to aspects described herein;

FIG. 3 depicts an example of a simplified perspective view of a calibrated thermometer, according to aspects described herein;

FIG. 4 depicts a simplified schematic block diagram of the circuitry of the thermometer calibrator of FIG. 1, interfacing with an external calibration system, according to aspects described herein;

FIG. 5 depicts an example of a simplified schematic diagram of the H-bridge of FIG. 4, according to aspects described herein;

FIG. 6 depicts an example of a flow diagram of a method of operation of the thermometer calibrator of FIG. 1, in accordance with aspects described herein;

FIG. 7 depicts an example of a flow diagram of a method of operation of the external calibration system of FIG. 4, in accordance with aspects described herein; and

FIG. 8 depicts an example of a flow diagram of a method of calibrating the thermometer calibrator of FIG. 4 via interaction with the external calibration system of FIG. 7, in accordance with aspects described herein.

### DETAILED DESCRIPTION

Certain examples will now be described to provide an overall understanding of the principles of the structure, function, manufacture, and use of the methods, systems, and devices disclosed herein. One or more examples are illustrated in the accompanying drawings. Those skilled in the art will understand that the methods, systems, and devices specifically described herein and illustrated in the accompanying drawings are non-limiting examples and that the scope of the present disclosure is defined solely by the claims. The features illustrated or described in connection with one example may be combined with the features of other examples. Such modifications and variations are intended to be included within the scope of the present disclosure.

The terms “significantly”, “substantially”, “approximately”, “about”, “relatively,” or other such similar terms that may be used throughout this disclosure, including the claims, are used to describe and account for small fluctuations, such as due to variations in processing from a reference or parameter. Such small fluctuations include a zero fluctuation from the reference or parameter as well. For example, they can refer to less than or equal to ±10%, such as less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%.

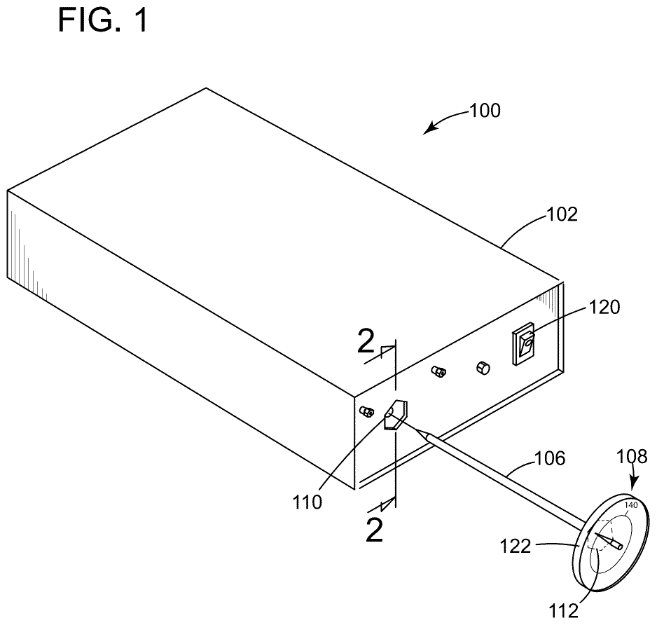

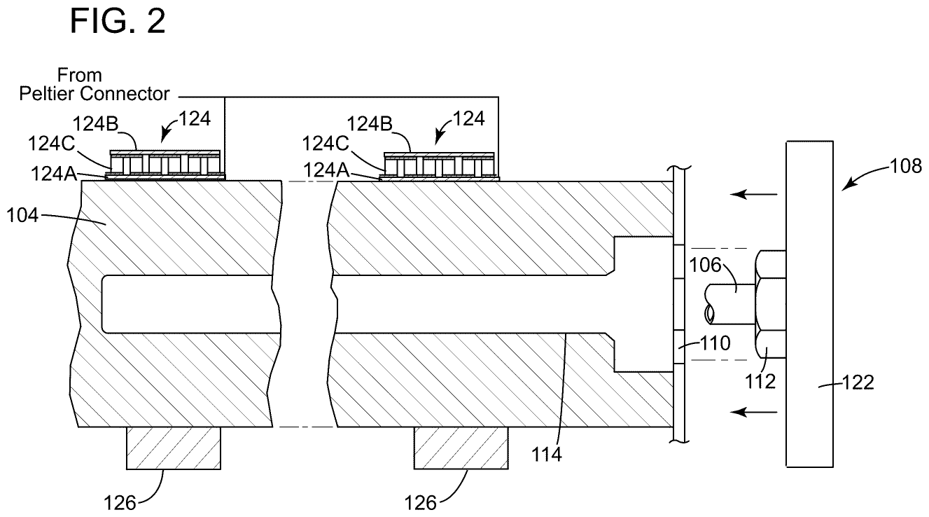

Referring to FIG. 1, an example is depicted of a perspective view of a thermometer calibrator 100, according to aspects described herein. The thermometer calibrator 100 includes a housing 102 and a thermally controlled receptacle 104 (see FIG. 2) that is configured to receive stems 106 of uncalibrated thermometers 108 to be calibrated at one or more set point temperatures.

The housing 102 includes a power switch 120 configured to engage electrical power to the thermometer calibrator 100. The housing 102 also includes a calibration socket 110 which is shaped to engage an adjuster 112, in the form of an adjustment nut 112, on the uncalibrated thermometer 108. When the stem 106 of the thermometer 108 is inserted through calibration socket 110, the socket 110 engages the adjuster 112 on the thermometer 108. This engagement holds the adjuster 112 against rotation to facilitate adjustment of the thermometer 108 while the thermometer 108 remains inserted in the receptacle 104.

Referring to FIG. 2, an example is depicted of a fragmentary cross sectional side view of a receptacle 104 of the thermometer calibrator 100 of FIG. 1, taken along the line 2-2 of FIG. 1, according to aspects described herein. The receptacle 104 includes a cylindrical bore 114 that is configured to receive the stem 106 of the thermometer 108 inserted therein. The cylindrical bore 114 may engage as much of the stem 106 of the thermometer 108 as possible to ensure proper heating of the stem 106.

The receptacle 104 may have multiple bores 114 to accommodate different diameter stems. For example, there may be two, three or more bores 114 positioned in the receptacle.

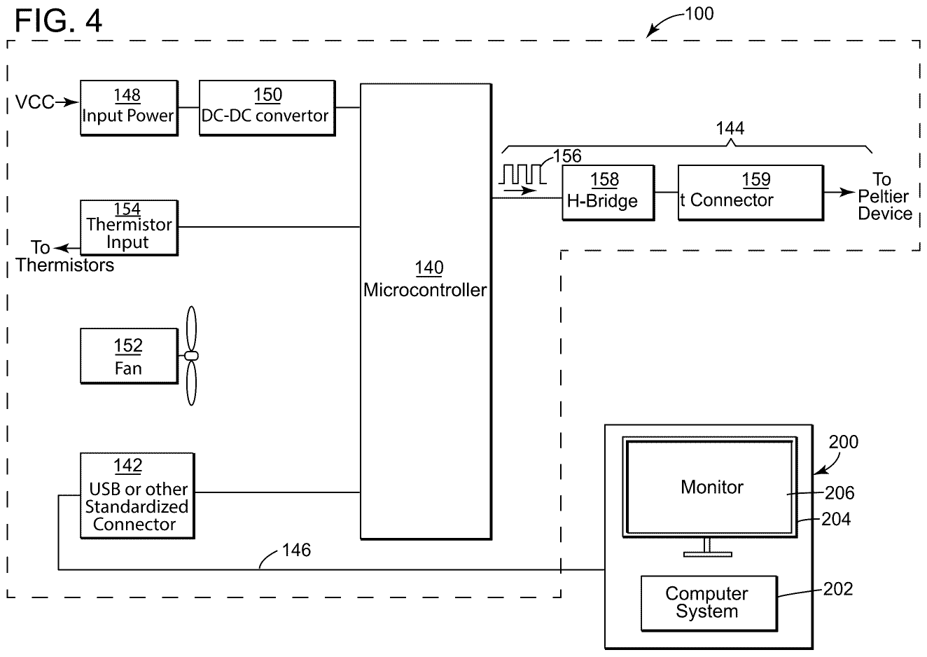

Thermally bonded to the receptacle 104 are one or more Peltier devices 124 which, as will be described in greater detail herein, are part of thermal control circuitry used to provide active heating and cooling to the receptacle 104. Also thermally bonded to the receptacle 104 are one or more thermistors 126, which may be used to provide temperature feedback signals to an external calibration system 200 (see FIG. 4).

The Peltier devices 124 include a first plate 124A, a second plate 124B that are separated by a set of alternating N-type and P-type pillars 124C. In the example shown in FIG. 2, the first plate 124A of each Peltier device 124 is bonded to the receptacle 104.

The Peltier devices 124 are solid state active heat pumps that transfer heat from one side (or plate) of the device to the other side (or plate) of the device with the application of electric energy, depending on the direction of the current. Therefore, via the well-known Peltier effect, the Peltier devices 124 are operable to conduct heat from their cooling plate to their heating plate, wherein the orientation of the cooling and heating plates depend on the polarity of the current passing through the Peltier devices 124.

Accordingly, when a current is passed through the Peltier devices 124 in a first polarity, the first plate 124A becomes the heating plate and the second plate 124B becomes the cooling plate. Therefore, when current passes through the Peltier devices in the first polarity, the Peltier devices 124 provide active heating to the receptacle 104. Alternatively, when a current is passed through the Peltier devices 124 in an opposite second polarity, the first plate 124A becomes the cooling plate and the second plate 124B becomes the heating plate. Therefore, when current passes through the Peltier devices in the second polarity, the Peltier devices 124 provide active cooling to the receptacle 104.

During operation for calibrating an uncalibrated thermometer 108, the operator powers up the thermometer calibrator 100 by engaging the power switch 120 (see FIG. 1) and selects a set point temperature to which the thermometer 108 is to be calibrated. The operator then inserts the thermometer stem 106 through the calibration socket 110 into a bore 114 until the calibration socket 110 engages the adjuster 112 of the thermometer 108. When the temperature indicated by the thermometer 108 has stabilized, the operator rotates the casing 122 of the thermometer 108 until the pointer (not shown) of the thermometer 108 is pointing to the selected set point temperature.

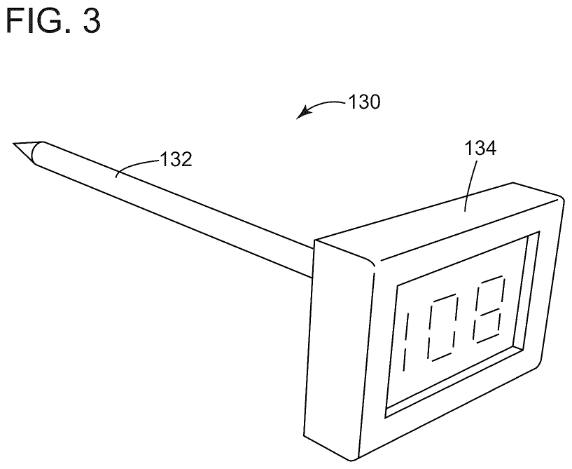

Referring to FIG. 3, an example is depicted of a simplified perspective view of a calibrated thermometer 130, according to aspects described herein. Much like the uncalibrated thermometers 108, the calibrated thermometer 130 also includes a stem 132 configured to be inserted into the receptacle 104 during a calibration process of the thermometer calibrator 100 itself. However, the calibrated thermometer 130 may be held to a significantly higher accuracy standard than the uncalibrated thermometers 108. For example, the calibrated thermometer 130 may be five (5), ten (10) or more times as accurate as that of the uncalibrated thermometers 108. Also by way of example, the calibrated thermometer may be calibrated, depending on the application, to an accuracy of plus or minus (+/−) 1 degree Fahrenheit (F), +/−0.5 degrees F, +/−0.2 degrees F, +/−0.1 degrees F, +/−0.1 degrees F or less.

The calibrated thermometer 130 may have been previously calibrated to such high accuracy standards, via an external calibration process traceable to a predetermined standard. The predetermined standard may be a standard that is in compliance with, for example, the National Institute of Standards and Technology (NIST).

The calibrated thermometer 130 may be calibrated to have an acceptable accuracy at a first set point temperature of one or more set point temperatures to which the thermometer calibrator 100 is required to be calibrated. The calibrated thermometer 130 may also be calibrated at several set point temperatures, or all of the set point temperatures, of the one or more set point temperatures required to calibrate the thermometer calibrator 100.

Note that the calibrated thermometer 130 might not be calibrated at any precise set point temperature to which the thermometer calibrator 100 is to be calibrated. Rather, the accuracy of the calibrated thermometer can be trusted at the set point temperature and, therefore, the calibrated thermometer 130 has an acceptable accuracy at the set point temperature. For example, when calibrating a thermometer calibrator 100 at 40 degrees Fahrenheit (F), a calibrated thermometer 130 may be used, which has been calibrated at 0 degrees F and 100 degrees F. In that case the calibrated thermometer 130 may be considered to have an acceptable accuracy at 40 degrees F, due to such non-limiting factors as: the 40 degrees F being within the range of 0 degrees F to 100 degrees F, or the high accuracy of the calibrated thermometer.

The calibrated thermometer 130 is configured to send a calibrated thermometer signal indicative of a temperature of its stem 132 to the external calibration system 200. This may be accomplished via visual readout 134, such as a dial or digital readout, wherein an operator can visually read the temperature of the stem 132 and manually input the temperature of the stem 132 into the external calibration system 200. Alternatively, the calibrated thermometer 130 may be in electrical communication with the external calibration system 200, for example by wired connections or by wireless transmission signals, wherein the external calibration system 200 may automatically receive the stem 132 temperature without any manual input.

Referring to FIG. 4, an example is depicted of a simplified schematic block diagram of the circuitry of the thermometer calibrator 100, interfacing with an external calibration system 200, according to aspects described herein.

The circuitry of the thermometer calibrator 100 includes a microcontroller 140 that is disposed within the housing 102 of the thermometer calibrator 100. The microcontroller 140 has a memory in communication with a processor. The memory is configured to store set point temperature data indicative of the one or more set point temperatures that are to be used to calibrate the thermometer calibrator 100. The microcontroller 140 is configured for electrical communication with an external calibration system 200, which may be through an input/output connector 142. The input/output connector may be, for example, a USB port or other standardized connector. The input/output connector 142 is configured to transfer data between the microcontroller 140 and the external calibration system 200.

Thermal control circuitry 144 is disposed within the housing 102 and in electrical communication with the microcontroller 140. The thermal control circuitry 144 is configured to control the temperature of the receptacle 104 (see FIG. 2) at the one or more set point temperatures based on the set point temperature data. The thermometer calibrator 100 is configured to be calibrated to control the temperature of the receptacle 104 at the one or more set point temperatures via control signals from the external calibration system 200. The control signals may be transmitted between the thermometer calibrator 100 and the external calibration system 200 through hard wires 146 as shown in the example of FIG. 4, or may be transmitted wirelessly.

A power source 148 provides input power (or VCC) to the thermometer calibrator circuitry. The power source may be, for example, a battery that supplies direct current (DC) directly to the system. Alternatively, the input power may be an AC to DC converter that receives alternating current (AC) power from an external electrical source. The input power may be in a range of, for example, 12 volts DC to 18 volts DC. The input power is stepped down to 5 volts DC via the DC to DC converter 150, which is used to provide power the microcontroller 140.

One or more fans 152 are used to regulate the temperature of the microcontroller 140 and the Peltier devices 124. The microcontroller receives feedback temperature signals from the thermistors 126 bonded to the receptacle 104 (see FIG. 2) through the thermistor input port 154. Though the temperature sensors 126 are illustrated herein as thermistor, other temperature sensors may also be used. For example, the temperature sensors may be thermocouples, resistance temperature detectors (RTDs) or various types of semi-conductor based integrated circuits. The microcontroller is configure to provide the feedback temperature signals The microcontroller 140 may be configured to store software instructions executable by the microcontroller's processor for a proportional integral derivative (PID) controller. The PID controller may be used to drive the thermal control circuitry 144 to control the temperature of the receptacle 104. As such, the set point temperature data stored in the microcontroller's memory may include adjustable gain data for the PID controller that is used to regulate the temperature of the receptacle 104 at the one or more set point temperatures.

The thermal control circuitry 144 may include pulse width modulated (PWM) signals 156 generated from the microcontroller 140. Thermal control circuitry 144 may also include an H-bridge circuit 158 configured to receive the PWM signals 156. The thermal control circuitry 144 may also include the one or more heating/cooling devices 124 (in this case the Peltier devices 124) electrically connected to the H-bridge circuit 158 through Peltier connector 159, wherein the heating/cooling devices are bonded to the receptacle 104 (see FIG. 2). The H-bridge 158 is configured to regulate power to the one or more heating/cooling devices 124 based on the PWM signals 156.

Though the heating/cooling devices are illustrated herein as Peltier devices 124, other heating/cooling devices may also be used. For example, the heating devices may be various types of heating resistors designed to convert electrical energy into heat energy. Also by way of another example, the cooling devices may be various types of fans for convective cooling.

The H-bridge 158 may also be configured to switch the regulated power applied to the Peltier devices 124 between a first polarity and a second polarity. Accordingly, in the first polarity, the Peltier devices 124 apply active heating to the receptacle 104, and in the second polarity, the Peltier devices 124 apply active cooling to the receptacle 104.

Optionally, the thermometer calibrator 100 may be fitted with an onboard computer or second microcontroller and monitor (not shown) to record usage or read/write properties of the thermometer calibrator 100. The monitor may include a touchscreen that allows a user to log data into and out of the thermometer calibrator 100.

The monitor (or onboard display) may be used to log usage, as well as view/update properties, of the thermometer calibrator 100. For example, the monitor of the thermometer calibrator 100 may record the thermometer calibrator's serial number, or the last calibration date, or the like.

The external calibration system 200 is configured to calibrate the thermometer calibrator 100 to control the temperature of the receptacle 104 of the thermometer calibrator 100 at the set point temperatures. The external calibration system 200 includes a computer system 202 and may include a monitor 204. The computer system 202 includes at least one calibration system memory and one or more calibration system processors in communication with the at least one calibration system memory.

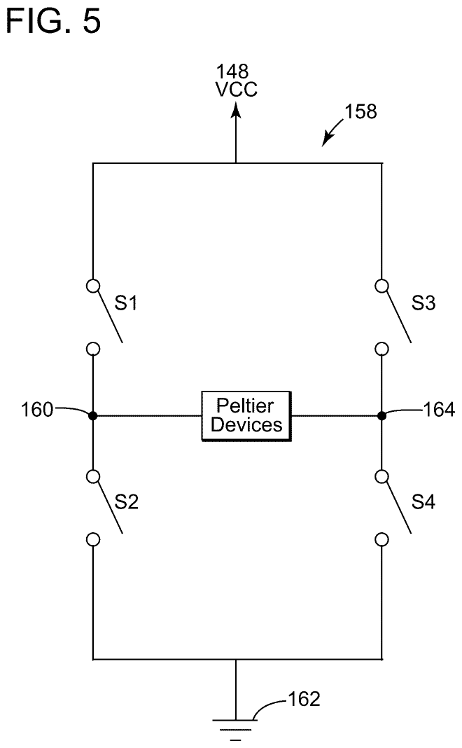

Referring to FIG. 5, an example of a simplified schematic diagram of the H-bridge 158, according to aspects described herein. The H-bridge in its simplest form includes four switches S1, S2, S3 and S4 that are controlled by the microcontroller 140. Switch S1 serially connects input power (or VCC) 148 to a first node 160. Switch S2 serially connects the first node 160 to ground 162. Switch S3 serially connects input power 148 to a second node 164. Switch S4 serially connects the second node 164 to ground 162. The Peltier devices 124 are connected across the first and second nodes 160, 164.

Switches S1 and S4 function as a first pair, wherein when switches S1 and S4 are closed, input power (VCC) 148 flows through the Peltier devices 124 in a first polarity to provide active heating to the receptacle 104. Switches S3 and S2 function as a second pair, wherein when switches S3 and S2 are closed, input power 148 flows through the Peltier devices 124 in a second polarity to provide active cooling to the receptacle 104. The timing of openings and closings of the first pair (S1 and S4) and the second pair (S3 and S2) of switches are controlled by the PWM signals 156. Accordingly, through the H-bridge circuit 158, the PWM signals 156 can control the amount and profile of the active heating and cooling that is provided by the Peltier devices 124 to the receptacle 104.

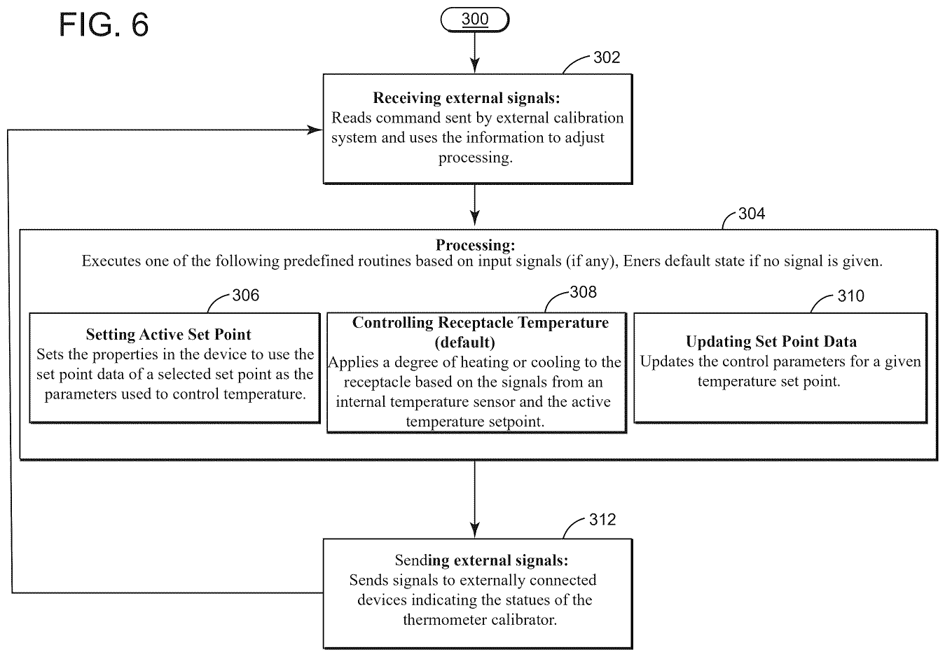

Referring to FIG. 6, an example is depicted a flow diagram of a method of operation of the thermometer calibrator 100, in accordance with aspects described herein.

The method begins at step 302, wherein external input signals are received (or input into) the thermometer calibrator 100. This may be in the form of a manual input by a user (such as via push buttons or typing), or electronically communicated by an external source, such as the external calibration system 200. For example, the external calibration system 200 may send command or control signals to the thermometer calibrator 100 that provide information requiring adjustments in the processing of the thermometer calibrator 100. The reception of external signals may be bypassed after a predetermined timeout period. In this case, the method will enter a default processing behavior described below.

At 304, once an input signal is received or the input has timed out, the thermometer calibrator 100 may execute one of at least the three following predefined routines at steps 306, 308 and 310. The execution of those routines will be based on the input signals received at step 302, if any. If no signals are received, the thermometer calibrator may enter a default state at step 308.

At 306, the input signals may require the setting of various properties in the thermometer calibrator 100 and, more specifically, in the memory of the microcontroller 140 of the of the thermometer calibrator 100. For example, the input signals may set properties of one or more set point temperature data of a selected set of set points, which are to be used as the parameters to control the temperature of the receptacle 104.

At 308, if no input signal is received, the thermometer calibrator may enter a default state, wherein the thermometer calibrator 100 controls the temperature of the receptacle 104 to a default (or currently active) set point temperature. In that case, the thermometer calibrator 100 may apply a degree of heating and/or cooling to the receptacle 104 based on the signals from an interna temperature sensor 126, to reach the active (or default) set point temperature.

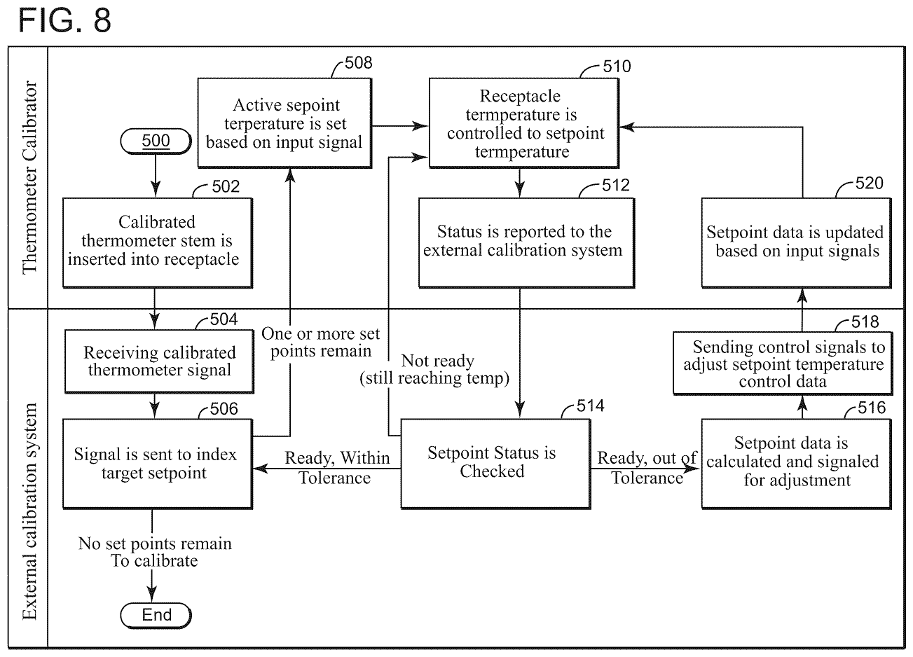

At 310, the input signals may require updating or adjusting the temperature control data (parameters) for a given set point temperature. This operation of adjusting the set point temperature data is done during a calibration of the thermometer calibrator, via the external calibration system 200, which will be described in greater detail with reference to FIG. 8 herein.

The method 300 may be stored within a memory of a microcontroller 104 of the thermometer calibrator 100. The method 300 may be stored in the memory of the microcontroller 104 as a set of instructions executable by the processor of the microcontroller 104.

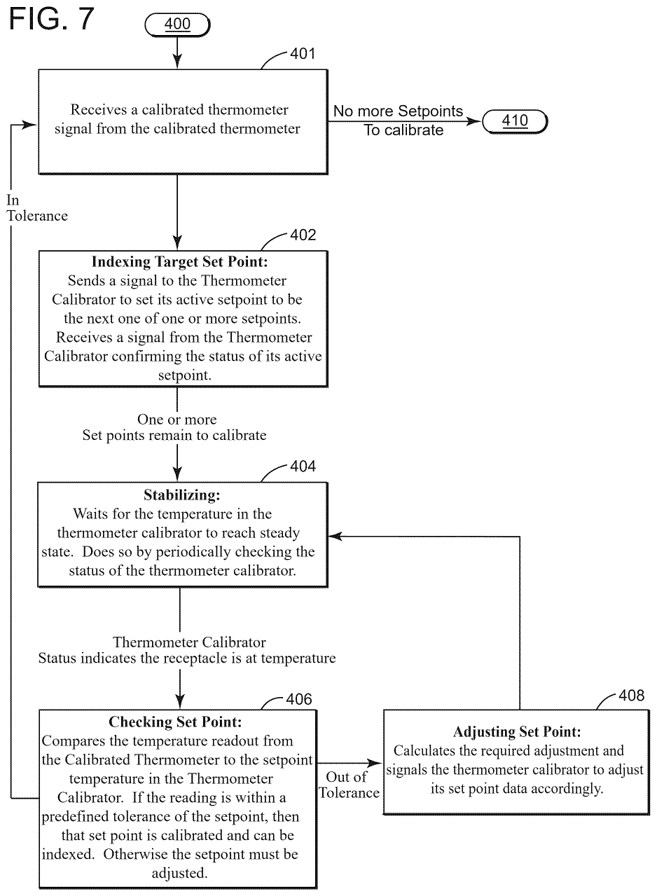

Referring to FIG. 7, an example is depicted of a flow diagram of a method 400 of operation of the external calibration system 200, in accordance with aspects described herein. The method 400 may be stored within a memory of the computer system 202 of the external calibration system 200.

The method starts at 401, wherein the external calibration system 200 receives calibrated thermometer signals from the calibrated thermometer 130. The calibrated thermometer signals are indicative of the temperature of the stem 132 of the calibrated thermometer, which has been inserted into the thermally controlled receptacle 104 of the thermometer calibrator 100. (This step is analogous to step 504 in method 500 of FIG. 8.)

At step 402, a command signal is sent from the external calibration system 200 to the thermometer calibrator 100 to control the temperature of the receptacle 104 to have an acceptable accuracy at a first set point temperature of the one or more set point temperatures to which the thermometer calibrator is to be calibrated. (This step is analogous to step 506 in method 500 of FIG. 8.)

At step 404, the external calibration system 200 enters a wait for stabilizing state, wherein it waits for the temperature of the receptacle 104 in the thermometer calibrator 100 to reach a steady state. More specifically, the external calibration system 200 waits to receive a feedback status signal from the thermometer calibrator 100 that the receptacle 104 has reached a steady state temperature at the first set point temperature. (This step is not shown in the flow chart 500 of FIG. 8)

At step 406, the external calibration system 200 receives the feedback status signal indicating that the receptacle 104 of the thermometer calibrator is at the first set point temperature. At that point the external calibration system 200 compares the temperature readout of the calibrated thermometer 130 to the first set point temperature. (This step is analogous to steps 514 in method 500 of FIG. 8.)

At step 408, if the calibrated thermometer signal from the calibrated thermometer 100 indicates that the temperature of the stem 132 is not within a predetermined tolerance range of the first set point temperature, then the external calibration system 200 calculates the required adjustments to the set point temperature control data. The external calibration system 200 then sends control signals to the thermometer calibrator 100 to adjust the set point temperature control data in accordance with the calculated adjustments. (This step is analogous to steps 516 and 518 in the method 500 of FIG. 8.)

The external calibration system 200 will then repeat steps 404, 406 and 408 until the calibrated thermometer 130 indicates that the temperature of the stem 132 is within the predetermined tolerance range of the first set point. (This step is analogous to repeating the steps 514, 516 and 518 in method 500 of FIG. 8.)

Thereafter, if there are other set point temperatures to that the thermometer calibrator 100 is required to be calibrated to, the external calibration system 200 will loop back to step 401. The method 400 will then be repeated until all of the set point temperature control data has been updated or adjusted for all of the set point temperatures.

The thermometer calibrator's operation (FIG. 6) runs in parallel with the external calibration system (FIG. 7). The interactions between the thermometer calibrator 100 and the external calibration system 200 as it pertains to executing a calibration of the thermometer calibrator are detailed in FIG. 8.

Referring to FIG. 8, an example is depicted of a flow diagram of a method 500 of calibrating the thermometer calibrator 100 via interaction with the external calibration system 200, in accordance with aspects described herein. The computer implemented method 500 for calibrating the thermometer calibrator 100 with the external calibration system 200 starts at step 502 by inserting the stem 132 of a calibrated thermometer 130 into the receptacle 104. The calibrated thermometer 130 has been previously calibrated to have an acceptable accuracy, via an external calibration process traceable to a predetermined standard, to at least a first set point temperature of one or more set point temperatures to which the thermometer calibrator 100 is to be calibrated.

At 504, a calibrated thermometer signal indicative of a temperature of the stem 132 is sent from the calibrated thermometer 130 and received by the external calibration system 200. The calibrated thermometer signal may be input into the external calibration system manually by a user reading the readout 134 of the calibrated thermometer 130, or may be transmitted electronically to the external calibration system, either via hard wires or wirelessly, to the external calibration system. Moreover, the transmission of the calibrated thermometer signal may be routed directly from the calibrated thermometer 130, which is inserted into the receptacle 104 of the thermometer calibrator 100, to the external calibration system 200. Alternatively, the calibrated thermometer signal may be transmitted from the calibrated thermometer 130, through the thermometer calibrator 100, and to the external calibration system 200.

At 506, a command signal is sent from the external calibration system 200 to the thermometer calibrator 100 to control the temperature of the receptacle 104 at the first set point temperature based on set point temperature control data indicative of the one or more set point temperatures stored in the memory of the microprocessor 140 of the thermometer calibrator 100. Optionally, the external calibration system 200 may send a command signal to index to another set point temperature of the one or more set point temperatures, and to control the temperature of the receptacle 104 at the indexed set point temperature.

At 508, the command signal is received by the thermometer calibrator 100 and sets the first set point temperature that the receptacle 104 is to be controlled at.

At 510, the thermometer calibrator 100 actively applies heating and/or cooling to thermally control the temperature of the receptacle 104 at the first set point temperature based on the set point temperature control data. To do this, the microcontroller 140 may provide pulse width modulated (PWM) signals 156 to the Peltier devices 124. The PWM signals may be guided by the set point temperature control data to bring the receptacle 104 to the first set point temperature.

At 512, feedback status signals are sent from the thermometer calibrator 100 to the external calibration system 200 indicative of the status of the thermally controlled receptacle 104 having reached the first set point temperature. Prior to reaching the first set point temperature, the feedback status signals may indicate that the first set point temperature has not been reached and that the external calibration system must enter a wait or standby mode until the feedback status signals indicate that the first set point temperature is reached.

At 514, the feedback status signals that indicate that the first set point temperature has been reached are received by the external calibration system 200. At that point, the external calibration system 200 checks the calibrated thermometer signal of the calibrated thermometer 130.

At 516, if the calibrated thermometer signal indicates that the temperature of the stem 132 of the calibrated thermometer 130 is not within a predetermined tolerance range of the first set point temperature, then the external calibration system 200 calculates adjustments to the set point temperature control data.

At 518, control signals are sent from the external calibration system 200 to the thermometer calibrator 100 to adjust the set point temperature control data in accordance with the calculated adjustments.

At 520 the control signals are received by the thermometer calibrator 100. The thermometer calibrator then adjusts or updates the set point temperature control data, which is stored in the memory of the microprocessor 140 in accordance with the calculated adjustments.

Thereafter the steps of thermally controlling (510), sending feedback status signals (512), receiving feedback status signals (514), calculating adjustments (516), sending control signals (518) and receiving control signals (520) are repeated until the calibrated thermometer signal indicates that the temperature of the stem 132 is within the predetermined tolerance range of the first set point temperature.

If there are other set point temperatures of the one or more set point temperatures that the thermometer calibrator 100 is to be calibrated to, then the external calibration system 200 may send a command signal to the thermometer calibrator 100, for example via step 506, to control the temperature of the receptacle at the next set point temperature. Thereafter, the method 500 may be repeated until the thermometer calibrator 100 has been calibrated to all the set point temperatures of the one or more set point temperatures stored in the memory of the microprocessor 140. More specifically the steps of:
sending a calibrated thermometer signal (504),
sending a command signal (506),
receiving the command signal (508),
thermally controlling (510),
sending feedback status signals (512),
receiving feedback status signals (514),
calculating adjustments (516),
sending control signals (518),
receiving control signals (520), and
repeating the steps of thermally controlling (510), sending feedback status signals (512), receiving feedback status signals (514), calculating adjustments (516), sending control signals (518) and receiving control signals until (520),
   may be repeated for another set point temperature of the one or more set point temperatures until the stored set point temperature control data has been adjusted for all set point temperatures of the one or more set point temperatures.

The computer implemented method 500 of calibrating the thermometer calibrator 100 via interaction with the external calibration system 200 provides significant technological improvements in at least the field of thermometer calibration. Some non-limiting examples of technology advantages and improvements associated with the calibration method 500, and associated thermometer calibrator 100 and external calibration system 200, include the following:
Calculated adjustments result in reduced assembly time.
   Prior art processes of calibrating a thermometer calibrator relies on an operator to adjust a screw to tune the temperature up/down to calibrate thermometer calibrators. The amount by which a screw should be turned is a decision the operator makes based on their experience. An inexperienced operator may require several attempts to calibrate within a given specification. Each attempt requires a waiting period for the thermometer calibrator's temperature to stabilize.
   The method 500 in FIG. 8 has a technology advantage in that the external calibration system may be programmed to make calculated adjustments, whereas a manual method would require the operator's experience to make estimated adjustments until suitable performance is established. Fewer adjustments are required when they are calculated rather than estimated, thereby reducing assembly time associated with waiting for those adjustments to stabilize.
Calculated adjustments means improved accuracy.
   Currently, adjustments are made based on operator's experience (as detailed above). Because this prior art method relies on estimates, the system's accuracy may be limited by the operator's skill in estimating.
   The method 500 in FIG. 8 has a technology advantage in that the external calibration system 200 may be programmed to make calculated adjustments, whereas a manual method would require the operator's experience to make estimated adjustments until suitable performance is established. Calculated adjustments offer finer resolution than operator estimates, which means the thermometer calibrator may be calibrated to a tighter accuracy.
Direct communication with the thermometer calibrator means reduced assembly time.
   The thermometer calibrator has an indicator displaying if the status of the unit is ready or not. Currently in prior art thermometer calibrators, this indicator is visible as a light to the user, but cannot be communicated electronically to the external calibration system 200. Because the temperature status is currently unknown to the external calibration system, the current prior art process tracks temperature to assess when a thermometer calibrator has stabilized at a temperature over a predetermined time period.
   The method 500 in FIG. 8 has a technology advantage in that the external calibration system 100 can communicate electronically with the thermometer calibrator 200 to know its temperature status. In doing so, the external calibration system 200 no longer needs to wait until the thermometer calibrator displays stable behavior. Instead, the external calibration system, 200 can proceed when the thermometer calibrator 100 indicates a ready status. This saves the external calibration system 200 from having to wait the predetermined time period and reduces assembly time.

It should be appreciated that all combinations of the foregoing concepts and additional concepts discussed in greater detail herein (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

Although the invention has been described by reference to specific examples, it should be understood that numerous changes may be made within the spirit and scope of the inventive concepts described. Accordingly, it is intended that the disclosure not be limited to the described examples, but that it has the full scope defined by the language of the following claims.

What is claimed is:

1. A thermometer calibrator comprising:
a housing containing a thermally controlled receptacle configured to receive stems of uncalibrated thermometers to be calibrated at one or more set point temperatures;
a microcontroller disposed within the housing, the microcontroller having a memory in communication with a processor, the memory configured to store set point temperature control data indicative of the one or more set point temperatures, the microcontroller configured for electrical communication with an external calibration system; and
thermal control circuitry disposed within the housing and in electrical communication with the microcontroller, the thermal control circuitry configured to control the temperature of the receptacle at the one or more set point temperatures based on the set point temperature control data;
wherein the thermometer calibrator is configured to be calibrated to control the temperature of the receptacle at the one or more set point temperatures via control signals from the external calibration system.

2. The thermometer calibrator of claim 1, wherein the microcontroller is configured to perform a method of calibrating the thermometer calibrator, the method comprising:
inserting a stem of a calibrated thermometer into the receptacle, the calibrated thermometer configured to send a calibrated thermometer signal indicative of a temperature of the stem to the external calibration system, wherein the calibrated thermometer has been previously calibrated to have an acceptable accuracy, via an external calibration process traceable to a predetermined standard, to at least a first set point temperature of the one or more set point temperatures;
receiving a command signal from the external calibration system to control the temperature of the receptacle at the at least first set point temperature based on the set point temperature control data;
thermally controlling the temperature of the receptacle at the at least first set point temperature based on the set point temperature control data;
sending feedback status signals to the external calibration system indicative of the status of the thermally controlled receptacle having reached the at least first set point temperature;
if the calibrated thermometer signal indicates that the temperature of the stem is not within a predetermined tolerance range of the at least first set point temperature, then receiving control signals from the external calibration system to adjust the set point temperature control data in accordance with adjustment calculated by the external calibration system; and
repeating the steps of thermally controlling, sending feedback status signals and receiving control signals until the calibrated thermometer signal indicates that the temperature of the stem is within the predetermined tolerance range of the first set point.

3. The thermometer calibrator of claim 2, wherein the method further comprises:
repeating the steps of:
receiving a command signal
thermally controlling,
sending feedback status signals,
receiving control signals, and
repeating the steps of thermally controlling, sending feedback status signals and receiving control signals until,
for another set point temperature of the one or more set point temperatures until the stored set point temperature control data has been adjusted for all set point temperatures of the one or more set point temperatures.

4. The thermometer calibrator of claim 2, wherein the microcontroller is configured to store software instructions executable by the processor for a proportional integral derivative (PID) controller, the PID controller used to drive the thermal control circuitry to control the temperature of the receptacle.

5. The thermometer calibrator of claim 4, wherein the set point temperature control data comprises adjustable gain data for the PID controller.

6. The thermometer calibrator of claim 5, wherein the method step of receiving control signals from the external calibration system to adjust the set point temperature control data comprises receiving control signals from the external calibration system to adjust the gain data for the PID controller.

7. The thermometer calibrator of claim 1, wherein the thermal control circuitry comprises pulse width modulated (PWM) signals generated from the microcontroller.

8. The thermometer calibrator of claim 7, wherein the thermal control circuitry comprises:
an H-bridge circuit configured to receive the PWM signals; and
one or more heating/cooling devices connected to the H-bridge circuit and bonded to the receptacle; and
wherein the H-bridge is configured to regulate power to the one or more heating/cooling devices based on the PWM signals.

9. The thermometer calibrator of claim 8, comprising:
the one or more heating/cooling devices comprising one or more Peltier devices; and
the H-bridge being configured to switch the regulated power applied to the Peltier devices between a first polarity and a second polarity;
wherein in the first polarity, the Peltier devices apply active heating to the receptacle, and in the second polarity, the Peltier devices apply active cooling to the receptacle.

10. The thermometer calibrator of claim 1, comprising at least one temperature sensor bonded to the receptacle, the at least one temperature sensor configured to provide feedback temperature signals to the microcontroller indicative of the temperature of the receptacle.

11. The thermometer calibrator of claim 10, wherein the at least one temperature sensor comprises at least one of a thermistor, a thermocouple, a resistance temperature detector (RTD) or a temperature sensor having a semiconductor based integrated circuit.

12. The thermometer calibrator of claim 1, comprising an input/output connector configured to transfer data between the microcontroller and the external calibration system.

13. The thermometer calibrator of claim 12, wherein the input/output connector is a USB or other standardized connector.

14. A computer implemented method for calibrating a thermometer calibrator with an external calibration system, the method comprising:
inserting a stem of a calibrated thermometer into the receptacle, wherein the calibrated thermometer has been previously calibrated to have an acceptable accuracy, via an external calibration process traceable to a predetermined standard, to at least a first set point temperature of one or more set point temperatures;
sending a calibrated thermometer signal indicative of a temperature of the stem to the external calibration system from the calibrated thermometer,
sending a command signal from the external calibration system to the thermometer calibrator to control the temperature of the receptacle at the at least first set point temperature based on set point temperature control data indicative of the one or more set point temperatures stored in a memory of a microprocessor of the thermometer calibrator;
receiving the command signal by the thermometer calibrator;
thermally controlling, by the thermometer calibrator, the temperature of the receptacle at the at least first set point temperature based on the set point temperature control data;
sending feedback status signals from the thermometer calibrator to the external calibration system indicative of the status of the thermally controlled receptacle having reached the at least first set point temperature;
receiving the feedback status signals by the external calibration system;
if the calibrated thermometer signal indicates that the temperature of the stem is not within a predetermined tolerance range of the at least first set point temperature, then calculating adjustments to the set point temperature control data by the external calibration system;
sending control signals from the external calibration system to the thermometer calibrator to adjust the set point temperature control data in accordance with the calculated adjustments;
receiving the control signals by the thermometer calibrator; and
repeating the steps of thermally controlling, sending feedback status signals, receiving feedback status signals, calculating adjustments, sending control signals and receiving control signals until the calibrated thermometer signal indicates that the temperature of the stem is within the predetermined tolerance range of the at least first set point temperature.

15. The method of claim 14, comprising:
repeating the steps of:
sending a calibrated thermometer signal
receiving a calibrated thermometer signal
sending a command signal
receiving the command signal,
thermally controlling,
sending feedback status signals,
receiving feedback status signals,
calculating adjustments,
sending control signals,
receiving control signals and
repeating the steps of thermally controlling, sending feedback status signals,
receiving feedback status signals, calculating adjustments, sending control signals and receiving control signals until,
for another set point temperature of the one or more set point temperatures until the stored set point temperature control data has been adjusted for all set point temperatures of the one or more set point temperatures.

16. The method of claim 14, comprising:
storing software instructions in the memory of the microcontroller of the thermometer calibrator for a proportional integral derivative (PID) controller, wherein the software instructions are executable by a processor of the microcontroller; and
driving the thermal control circuitry with the PID controller to control the temperature of the receptacle.

17. The method of claim 16, wherein the set point temperature control data comprises adjustable gain data for the PID controller.

18. The method of claim 17, wherein the method step of calculating adjustments to the set point temperature control data comprises calculating adjustments to the gain data for the PID controller.

19. An external calibration system configured to calibrate a thermometer calibrator to control a temperature of a receptacle of the thermometer calibrator at one or more set point temperatures, the external calibration system comprising a computer system, wherein the computer system comprises:
at least one calibration system memory; and
one or more calibration system processors in communication with the at least one calibration system memory, wherein the computer system is configured to perform a method, the method comprising:
receiving a calibrated thermometer signal from a calibrated thermometer indicative of a temperature of a stem of the calibrated thermometer inserted into the receptacle of the thermometer calibrator, wherein the calibrated thermometer has been previously calibrated to have an acceptable accuracy, via an external calibration process traceable to a predetermined standard, to at least a first set point temperature of the one or more set point temperatures,
sending a command signal to the thermometer calibrator to control the temperature of the receptacle at the at least first set point temperature of the one or more set point temperatures based on set point temperature control data stored in a memory of a microprocessor of the thermometer calibrator,
receiving feedback status signals from the thermometer calibrator indicative of the status of the thermally controlled receptacle having reached the at least first set point temperature,
if the calibrated thermometer signal from the calibrated thermometer indicates that the temperature of the stem is not within a predetermined tolerance range of the at least first set point temperature, then calculating adjustments to the set point temperature control data,
sending control signals from the external calibration system to the thermometer calibrator to adjust the set point temperature control data in accordance with the calculated adjustments, and
repeating the steps of receiving feedback status signals, calculating adjustments and sending control signals until the calibrated thermometer indicates that the temperature of the stem is within the predetermined tolerance range of the at least first set point.

20. The external calibration system of claim 19, wherein the method further comprises:
repeating the steps of:
receiving a calibrated thermometer signal,
sending a command signal,
receiving feedback status signals,
calculating adjustments,
sending control signals, and
repeating the steps of receiving feedback status signals, calculating adjustments and sending control signals until,
for another set point temperature of the one or more set point temperatures until the stored set point temperature control data has been updated for all set point temperatures of the one or more set point temperatures.
